(19) United States
(12) Patent Application Publication
(10) Pub. No.: US 2022/0368254 A1
(43) Pub. Date: Nov. 17, 2022

(54) Adjusting Device, Motor-Driven Valve and Method for Operating an Adjusting Device

(71) Applicant: Oblamatik AG, Chur (CH)

(72) Inventors: Thomas KNUPFER, Landquart (CH); Roland OBRIST, Scharans (CH)

(73) Assignee: Oblamatik AG, Chur (CH)

(21) Appl. No.: 17/737,606

(22) Filed: May 5, 2022

(30) Foreign Application Priority Data
May 12, 2021 (CH) 00538/21

(51) Int. Cl. H02P 7/00; G05D 3/12

(52) U.S. Cl. CPC H02P 7/0094; G05D 3/12

(57) ABSTRACT

An adjusting device having a DC motor and an adjusting member driven by an output shaft of the DC motor is disclosed. The adjusting device has a power driver coupled to the DC motor for controlling a motor current of the DC motor, a current measurement circuit that is adapted to detect a current consumption of the DC motor and to output a current measurement signal dependent on the number of revolutions of the DC motor, and a computing unit, to which the current measurement signal is input adapted to determine the number of revolutions of the DC motor based on the current measurement signal.

The present invention relates to an adjusting device, a motor-driven valve and a method for operating an adjusting device.

In sanitary engineering, for example, an adjusting device can be understood as a unit which can also be described as operating part of a sanitary fitting. Such adjusting devices can include valves. Adjusting devices can be operated manually with a lever (single-lever mixer) or via an electronic control element by a valve with a motor-driven adjusting member. In this case, the adjusting member can be driven by an output shaft of an electric motor. Adjusting devices are known which are designed for battery operation. This avoids the need to lay electrical cables, which can cause problems, especially in sanitary rooms.

It is known in the prior art to use stepper motors for adjusting devices. This has the advantage that the angular degree can be determined precisely. Once calibrated, the adjusting member can be adjusted precisely, e.g. from a closed position to a desired open position and from there precisely back to the closed position. Further components, e.g. position sensors, can thus be dispensed with. One disadvantage of using stepper motors is their high power consumption. Thus, in the case of battery-powered adjusting devices, the batteries have to be replaced frequently, which is tedious and expensive. In addition, stepper motors are very expensive to purchase.

Therefore, it is known in the prior art to use DC motors instead of stepper motors to realize a motor-driven valve. DC motors have the advantage over stepper motors that only as much energy as necessary is used to drive the motor. The service life of the batteries used is extended, so that replacement is only necessary after very long intervals. In addition, DC motors are cost-effective.

One disadvantage of using a DC motor, however, is that an encoder is required to check how far the DC motor has travelled in order, for example, to determine the position of the adjusting member. For example, the position can be determined optically or magnetically. Such an encoder is expensive, awkward to place and means additional components on the adjusting device.

It is object of the present invention to provide an adjusting device, a motor-driven valve and a method for operating an adjusting device which do not have the above-mentioned disadvantages.

This object is solved by the features indicated in the characterizing part of claim 1. Advantageous embodiment variants as well as a motor-driven valve and a method for operating an adjusting device are given in further claims.

According to the invention, an adjusting device comprises a DC motor and an adjusting member driven by an output shaft of the DC motor. Further, the adjusting device comprises a power driver coupled to the DC motor for controlling a motor current of the DC motor, a current measurement circuit adapted to detect a current consumption of the DC motor and to output a current measurement signal depending on the number of revolutions of the DC motor, and a computing unit, to which the current measurement signal is input, adapted to determine the number of revolutions of the DC motor based on the current measurement signal. The adjusting device detects a change in current when the polarity of the commutator of the DC motor is changed. Since the commutator is firmly connected to the drive shaft, this allows reliable conclusions to be drawn about the revolutions made and thus about the position of the driven adjusting member.

In other words, the adjusting device taps the current drawn by the DC motor and determines the “steps” of the DC motor based on the current measurement signal. This can be used to infer the position of the DC motor, and thus the adjusting device. This may require that the initial position, e.g. a stop, of the adjusting member is known. Such an initial position can be, for example, a closed position of the valve in which the adjusting member is located at a stop.

In a preferred embodiment of the adjusting device, the computing unit is adapted to determine the number of revolutions of the DC motor based on a ripple of the current measurement signal, in particular based on pulses of the current measurement signal. This embodiment allows conclusions to be drawn about the number of revolutions of the DC motor without additional components, but merely on the basis of the detected ripple of the current measurement signal. From this, the position of the adjusting member can be easily determined. The ripple can include any frequency components in the current measurement signal, e.g. sinusoidal waveforms, pulses, etc.

In a preferred embodiment, the adjusting device further comprises an electrical filter connected downstream of the current measurement circuit, designed to block low-frequency components of the current measurement signal and to allow high-frequency components of the current measurement signal to pass. For example, high-pass filtering of the current measurement signal allows detection or processing of fast changes or of high-frequency signal components. The information from this can be used to draw conclusions about the rotation of the DC motor happened.

In a preferred embodiment, the adjusting device further comprises an amplifier coupled to the electrical filter, adapted to amplify the output signal of the electrical filter. In a preferred embodiment of the adjusting device, the computing unit is connected downstream of the amplifier, configured to read in the filtered and/or amplified current measurement signal. The amplifier can amplify the rapid changes in the current measurement signal to such an extent that they can be input directly or indirectly to the computing unit. In this way, the adjustment of the adjusting member can be continuously tracked, e.g. also while moving, and conclusions can be drawn about the respective position of the adjusting member.

In a preferred embodiment of the adjusting device, the computing unit is coupled to the power driver for controlling the motor current of the DC motor. Furthermore, preferably, the computing unit is adapted to control the power driver based on the detected number of revolutions of the DC motor. Thus, a control loop can be implemented.

In a preferred embodiment of the adjusting device, the computing unit is adapted to control the DC motor in such a way as to move the motor-driven adjusting member to at least one predetermined position. Furthermore, the computing unit is preferably adapted to control the power driver in such a way as to move the motor-driven adjusting member to at least one predetermined position. The DC motor can be controlled directly by the computing unit or via the interconnected power driver.

In a preferred embodiment of the adjusting device, the computing unit is further adapted to control the DC motor in such a way as to track a change in the position of the adjusting member. Furthermore, preferably, the predetermined position has at least one closed position and/or one open position of the motor-driven adjusting member.

The invention further relates to a motor-driven valve comprising an adjusting device according to one of claims 1 to 11. The motor-driven valve is driven by a low-cost and energy-saving DC motor. Advantageously, the adjusting device can be operated in battery mode. At the same time, the use of additional position sensors, e.g. an encoder, can be advantageously avoided.

The invention further relates to a method for operating an adjusting device according to one of claims 1 to 11, comprising the steps of: detecting a current consumption of the DC motor, generating, based on the detected current consumption, a current measurement signal dependent on the number of revolutions of the DC motor, and determining the number of revolutions of the DC motor based on the current measurement signal.

In a preferred embodiment, the method further comprises the step of: determining the position of the adjusting member based on the determined number of revolutions of the DC motor. Further preferably, the number of revolutions of the DC motor is determined based on a ripple of the current measurement signal, in particular based on pulses of the sensor signal.

It is expressly pointed out that the above embodiment variants can be combined in any way. Only those combinations of embodiment variants are excluded which would lead to contradictions due to the combination.

In the following, the present invention is further explained with reference to exemplary embodiments shown in the drawing, wherein:

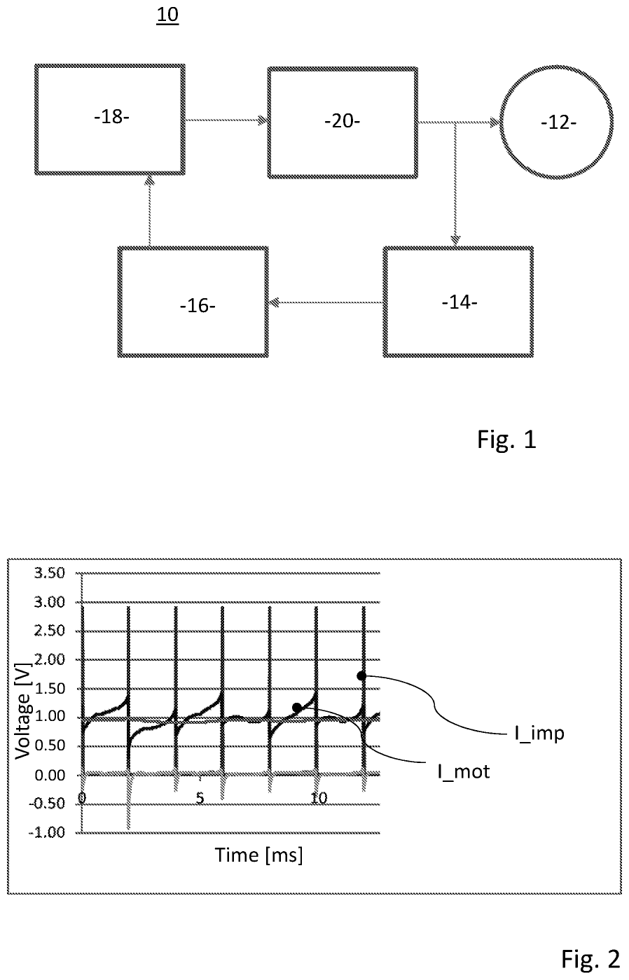

FIG. 1 shows a block diagram of an adjusting device according to an exemplary embodiment, and

FIG. 2 shows a diagram of a voltage curve.

FIG. 1 shows a block diagram of an adjusting device 10 according to an exemplary embodiment. The adjusting device 10 comprises a motor, which according to the invention is designed as a DC motor 12. The DC motor 12 has an output shaft via which an adjusting member of the adjusting device is driven. The adjusting member may be designed as a valve body of a valve. A current measurement circuit 14 taps a current consumption of the DC motor 10, and outputs a current measurement signal to an amplifier 16 depending on the number of revolutions of the DC motor 10. The current measurement signal has a ripple caused by changes in current when a commutator of the DC motor 10 reverses polarity.

Although not shown, the current measurement signal may pass through at least one high pass filter that blocks low frequency components of the current measurement signal and passes high frequency components of the current measurement signal. The high-pass-filtered current measurement signal may be output to the amplifier 16. Alternatively or additionally, a high-pass filter may be connected downstream of the amplifier 16. Optionally, the amplifier 16 may be omitted and only a high-pass filter may be connected downstream of the current measurement circuit 14.

The current measurement signal passed through at least one high-pass filter is input to a computing unit 18. This computing unit 18 is coupled to a power driver 20, which is configured to control a motor current supplied to the DC motor 12. Here, the computing unit 18 may be configured to control the power driver 20 based on the detected number of revolutions of the DC motor 12. Thus, a control loop can be implemented.

The computing unit 18 can control the DC motor 12 in such a way as to move the driven adjusting member to at least one predetermined position. Optionally, the computing unit 18 can control the power driver 20 in such a way as to move the driven adjusting member to at least one predetermined position. The computing unit 18 may further drive the DC motor 12 in such a way as to track a change in the position of the adjusting member, wherein the predetermined position may be a closed position and/or an open position of the motor-driven adjusting member.

The adjusting device 10 determines the “steps” of the DC motor 12. As a result, the position of the DC motor 12 and optionally, for example, of a cartridge can be concluded. For this purpose, an initial position, e.g. a stop or a closed position and/or an open position of the motor-driven adjusting member, should be known. The adjusting device 10 detects the change in current when the polarity of the commutator of the DC motor 12 is reversed. Since the commutator is firmly coupled to the drive shaft of the DC motor 12, it is possible to reliably infer the revolutions made and thus the position of the driven adjusting member in a previously unknown manner.

The adjusting device 10 first measures the current drawn by the DC motor 12. This current can then be high-pass filtered so that only fast changes are processed. These changes can be amplified to such an extent that they can be read in directly, for example by the computing unit 18. In this way, the path traveled can be continuously tracked while moving, and the absolute position can be inferred from this. The invention makes it possible to retain the advantages of the DC motor 12 in battery operation and at the same time to omit an encoder.

FIG. 2 illustrates an exemplary curve of a voltage I_mot tapped directly at the DC motor of the adjusting device shown in FIG. 1, and an exemplary voltage curve I_imp resulting from processing on the directly tapped voltage I_mot. A bias voltage of the voltage I_mot tapped directly at the DC motor is at a potential of +1 V. The course or the ripple of the voltage I_mot tapped directly at the DC motor results from current changes when the polarity of the commutator of the DC motor is changed. Pulse-like changes can already be seen here, each with a time interval of 2 ms. The respective amplitudes, starting from the zero line, do not exceed the span of +/−0.5 V.

This directly tapped voltage I_mot is subjected to the processing described above consisting of at least one high-pass filtering and one amplification. This results in clearly recognizable pulses (I_imp) in a voltage range between 0 V and +3 V and the likewise clearly recognizable time interval of 2 ms between adjacent pulses. From the frequency of 500 Hz that can be derived from this, conclusions can be drawn about the speed of the DC motor and thus the number of revolutions of the DC motor. Starting from a reference position of the adjusting member, e.g. a stop of the adjusting member in the closed position, it is possible to continuously track the position of the adjusting member. Advantageously, no further components, e.g. encoders, etc., are required for this. Another advantage is that a DC motor can be used, which can be operated with battery voltage.

1. An adjusting device (10), comprising a DC motor (12) and an adjusting member driven by an output shaft of the DC motor (12), further comprising:
a power driver (20) coupled to the DC motor (10) for controlling a motor current of the DC motor (10),
a current measurement circuit (14) which is adapted to detect a current consumption of the DC motor (12) and to output a current measurement signal dependent on the number of revolutions of the DC motor (12), and
a computing unit (18), to which the current measurement signal is input, adapted to determine the number of revolutions of the DC motor (12) based on the current measurement signal.

2. The adjusting device (10) according to claim 1, wherein the computing unit (18) is designed to determine the number of revolutions of the DC motor (12) based on a ripple of the current measurement signal, in particular based on pulses of the current measurement signal.

3. The adjusting device (10) according to claim 1, further comprising an electrical filter connected downstream of the current measurement circuit (14), adapted to block low-frequency components of the current measurement signal and to pass high-frequency components of the current measurement signal.

4. The adjusting device (10) according to claim 3, further comprising an amplifier (16) coupled to the electrical filter, adapted to amplify the output signal of the electrical filter.

5. The adjusting device (10) according to claim 4, wherein the computing unit (18) is connected downstream of the amplifier (16), adapted to read in the filtered and/or amplified current measurement signal.

6. The adjusting device (10) according to claim 5, wherein the computing unit (18) is coupled to the power driver (20) for controlling the motor current of the DC motor (12).

7. The adjusting device (10) according to claim 6, wherein the computing unit (18) is configured to control the power driver (20) based on the detected number of revolutions of the DC motor (12).

8. The adjusting device (10) according to claim 7, wherein the computing unit (18) is adapted to control the DC motor (12) such to move the motor-driven adjusting member to at least one predetermined position.

9. The adjusting device (10) according to claim 7, wherein the computing unit (18) is adapted to control the power driver (20) such to move the motor-driven adjusting member to at least one predetermined position.

10. The adjusting device (10) according to claim 8, wherein the computing unit (18) is further adapted to control the DC motor (12) such to track a change in the position of the adjusting member.

11. The adjusting device (10) according to claim 8, wherein the predetermined position comprises at least a closed position and/or an open position of the motor-driven adjusting member.

12. A motor-driven valve, comprising an adjusting device (10) according to claim 1.

13. A method for operating an adjusting device (10) according to claim 1, comprising the steps of:
detecting a current consumption of the DC motor (12),
generating, based on the detected current consumption, a current measurement signal dependent on the number of revolutions of the DC motor (12), and
determining the number of revolutions of the DC motor (12) based on the current measurement signal.

14. The method according to claim 13, further comprising the step of:
determining the position of the adjusting member based on the determined number of revolutions of the DC motor (12).

15. The method according to claim 13, wherein the number of revolutions of the DC motor (12) is determined based on a ripple of the current measurement signal, in particular based on pulses of the sensor signal.
